(19) United States
(12) Patent Application Publication
(10) Pub. No.: US 2008/0089698 A1
(43) Pub. Date: Apr. 17, 2008

(54) Optical arbitrary waveform generation and processing using spectral line-by-line pulse shaping

(76) Inventors: Zhi Jiang, West Lafayette, IN (US); Daniel E. Leaird, West Lafayette, IN (US); Andrew M. Weiner, West Lafayette, IN (US)

Correspondence Address: BRINKS HOFER GILSON & LIONE, P.O. BOX 10395, CHICAGO, IL, 60610, US

(21) Appl. No.: 11/804,477

(22) Filed: May 17, 2007

Related U.S. Application Data
(60) Provisional application No. 60/801,832, filed on May 19, 2006.

(51) Int. Cl. H04B 10/04

(52) U.S. Cl. 398/189; 398/183

(57) ABSTRACT

An apparatus and method is disclosed for producing arbitrary optical and electrical waveforms. The apparatus includes a means for accepting or generating a comb-like optical spectrum, and an optical pulse shaper. The optical pulse shaper includes a spatial dispersion means, and a spatial modulating means having the capability to substantially independently modulate a characteristic of each of a pair of optical spectral lines. The apparatus and method may be used to generate a variety of waveform types, and convert between waveform types such as RZ and NRZ.

This application claims priority to U.S. Provisional Application Ser. No. 60/801,832, filed on May 19, 2006, which is incorporated herein by reference.

### FEDERALLY SPONSORED RESEARCH OR DEVELOPMENT

The work described in this application was sponsored by The Defense Advanced Research Projects Agency (DARPA) under grant MDA972-03-1-0014.

### TECHNICAL FIELD

This application relates to an apparatus and method of optical processing for the generation of arbitrary optical or electrical waveforms.

### BACKGROUND

Generation or processing of arbitrary waveforms in the optical and electrical domains is a fundamental operation for many application areas. Unfortunately, arbitrary waveform generation techniques are presently available only for relatively low frequency electronic or optical signals.

Pulse shaping techniques allow intensity and phase manipulation of optical spectral components and synthesis of user specified pulse fields according the Fourier transform relationship. However, in these pulse shapers, spectral lines are manipulated in groups rather than individually, and that leads to pulses which are isolated from one another in time.

### SUMMARY

An apparatus and method for producing electrical or optical waveforms having arbitrary characteristics is disclosed.

In an aspect, the apparatus has an input portion adapted to receive an optical signal input, the signal having at least two individual spectral lines. The optical signal is spatially processed such that the amplitude or phase of adjacent spectral lines may be independently modulated. A output portion is adapted to spatially recombine the modulated optical signal.

In another aspect, the apparatus comprises a pulse shaper adapted to accept an optical signal input, the pulse shaper performing a spatial modulation of the optical input signal such that individual spectral lines, which may be spectral lines of an optical frequency comb, may be at least one of phase, amplitude or polarization modulated. The pulse shaper may recombine the modulated optical signal and output the signal. The output signal may be used in an optical system or an opto-electronic converter may be provided to convert the optical signal to an electrical waveform suitable for use in an electronic system, or to be radiated or received in an electromagnetic system.

In yet another aspect, the optical input signal may be one of an optical pulse train having a periodic repetition rate or a CW optical signal which has been or will be modulated by a periodic electro-optical signal. The modulation may be at least one of a phase, an amplitude, or a polarization characteristic of the optical signal.

A method of producing an electrical or optical waveform with arbitrary waveform characteristics includes providing an optical processor adapted to accept an optical signal, where the optical processor changes a value of at least one of the amplitude, phase or polarization of individual spectral lines, and recombines the optical signal into an output signal. The output signal may be coupled to an optical waveguide, which may be an optical fiber, or directed onto an electro-optical converter.

A method of waveform design includes determining the Fourier transform of a desired time domain electrical signal, modulating an input optical comb spectrum by the amplitude and phase of the Fourier coefficients of the frequency domain representation of the time domain signal; recombining the optical components of the optical comb signal, and outputting the recombined signal. The modulation may be substantially independently applied to at least a pair of optical spectral lines.

In another aspect, the apparatus includes means for spatially dispersing the optical spectrum of an optical signal, an optical spatial modulator adapted to accept the spatially dispersed optical signal and a modulating signal, and means for modulating at least one characteristic of the spatially dispersed optical signal. The means for modulating substantially independently modulates individual optical spectral lines of a comb-like optical spectrum.

### BRIEF DESCRIPTION OF THE DRAWINGS

FIG. 1 shows schematic diagrams of application examples using line-by-line pulse shaping;

FIG. 2 compares pulse shaping by: (a) manipulating groups of lines and, (b) manipulating individual lines;

FIG. 3 shows an experimental apparatus for arbitrary waveform generation using a line-by-line pulse shaper;

FIG. 4 shows an experimental setup using a modulated CW optical source;

FIG. 5 shows spectra of (a) input CW, (b) phase modulated CW at 9.0 GHz, and (c) phase modulated CW at 13.5 GHz;

FIG. 6(a) shows an optical time-domain waveform corresponding to the time domain waveform of FIG. 6(b), as measured by a sampling oscilloscope, and the intensity autocorrelation function of FIG. 6 (c);

FIG. 7 shows width and wavelength tunable return-to-zero pulse generation spectra controlled to have (a) two lines, (b) three lines and, (c) four lines;

FIG. 8 shows pulse-to-CW conversion and CW-to-CW wavelength conversion with the (a) optical spectrum of one filtered line, (b) the corresponding CW waveform detected by a photo-diode and, (c) the RF spectrum;

FIG. 9 shows two selected spectral lines controlled to be separated by (a) 2×9 GHz, (b) 3×9 GHz, (c) 4×9 GHz and, (d) 5×9 GHz; along with corresponding time domain waveforms;

FIG. 10 shows four spectral lines, where two lines in each pair are separated by 10 GHz and two inner lines between the two pairs are separated by 400 GHz;

FIG. 11 shows (a) four spectral lines (five consecutive lines with center line blocked), and (b, c); waveforms with different applied spectral phases, as measured by intensity cross-correlation

FIG. 12 shows RZ-to-NRZ format conversion by line-by-line pulse shaping: spectra and eye-diagrams for (a) data modulated RZ format with 4 spectral lines and, (b) converted NRZ format with only one spectral line; and

FIG. 13(a) shows a portion of the apparatus of FIG. 3 adapted for providing a two dimensional optical spatial dispersion; and, (b) a schematic illustration of the substantially orthogonal spatial dispersion.

### DETAILED DESCRIPTION

Exemplary embodiments may be better understood with reference to the drawings, but these embodiments are not intended to be of a limiting nature. Like numbered elements in the same or different drawings perform equivalent functions. In the following description, numerous specific details are set forth in the examples in order to provide a thorough understanding of the subject matter of the claims which, however, may be practiced without some or all of these specific details. When a specific feature, structure, or characteristic is described in connection with an example, it will be understood that one skilled in the art may effect such feature, structure, or characteristic in connection with other examples, whether or not explicitly stated herein. In other instances, well known process operations have not been described in detail in order not to unnecessarily obscure the description.

Where the terms optical frequency comb or spectral line are used, they should be understood to represent an idealization of the situation which obtains in practice where all signals, optical or electronic, have a finite bandwidth. That is, there is a practical lower limit on the optical spectral width of the energy in a spectral line. This bandwidth may be due to noise in the signal generation process, modulation of information on the carrier wave, or the like. When the terms comb or spectral line are used, they connote a signal having a bandwidth that is sufficiently small with respect to the separation between the spectral lines that a characteristic of an individual spectral lines may be modified without a substantial deleterious and uncorrectable modification of an adjacent spectral line. It will be appreciated that this criteria will have differing numerical values depending on the circumstances, but, generally the equivalent of a 3 dB contrast, or the equivalent in phase, is meant.

The terms optical frequency, optical wavelength, temporal period and repetition rate are used freely herein, as a person of ordinary skill in the art will recognize the Fourier transform relationship between such descriptions.

The term modulation will be understood as relating to the modification of a characteristic of an optical or electrical or electromagnetic signal in at least one of the spatial or temporal domains. Such modulation may be fixed with time or be time varying in any of the time, frequency or spatial domains. Modulation may alter a characteristic of amplitude, phase, or polarization.

An apparatus and method is disclosed for the production of arbitrary electrical and optical waveforms, including the filtering, processing or shaping of optical signals characterized by discrete optical frequencies. The discrete optical frequencies may be, for example, a comb, or regularly-spaced characteristic having narrow spectral lines corresponding to at least one of periodic optical pulses, a periodically modulated optical signal or broadened spectral lines associated with a train of pulses bearing an aperiodic modulation. Aperiodic modulation may be used to impart information to the waveform for the purposes of communications. The filtering part has sufficient optical resolution such that adjacent spectral lines may be processed substantially independently. The filtering may be configured to provide optical frequency resolution at a spectral line-by-line resolution level.

Pulse shaping techniques, based on intensity and phase manipulation (modulation) of optical spectral components permits synthesis of user-specified ultra-short pulse fields according to a Fourier transform relationship. When the pulse shaping may be used to independently manipulate the intensity and phase of individual spectral lines (line-by-line pulse shaping), essentially optical arbitrary waveform generation (O-AWG) can be achieved.

The processing apparatus may have a property that individual spectral frequency components can be modified in a programmable manner, which may be accomplished with minimal crosstalk between the spectral lines by means of a spatial light modulator incorporated into the pulse shaper. The pulse shaper may control one or more of the phase, amplitude, or polarization of the optical frequency spectral components. In addition to pulse shaper implementations, other means for spectral line-by-line optical filtering may be used, such as integrated optic devices based on ring resonators, wavelength division (WDM) demultiplexers, or the like.

The apparatus and method disclosed herein may be used, for example, for:

spectral line-by-line processing, filtering, or pulse shaping on optical frequency combs generated by periodic modulation of a continuous-wave (single frequency) laser source, by a mode-locked laser, or other optical comb generator;

spectral line-by-line processing or pulse shaping on optical frequency combs with frequency-broadened lines corresponding to a train of pulses bearing an aperiodic modulation;

spectral line-by-line processing or pulse shaping using a filtering device with large free-spectral-range;

spectral line-by-line processing or pulse shaping using a grating-based optical pulse shaper;

spectral line-by-line processing or pulse shaping in which at least one of the amplitude, phase, or polarization-state of the optical frequency components is modulated or manipulated (one example is amplitude filtering, whereby a group of individual spectral lines is selected out of the frequency comb to generate pulses whose duration and center frequency are controlled by the group of lines selected); and

spectral line-by-line processing or pulse shaping in which a single spectral line is selected, resulting in conversion of a periodic pulsed signal into a continuous-wave, single frequency optical signal.

Herein, the term “processing” should be interpreted to include, but not be limited to, “pulse shaping” or other modulation or manipulation of at least one of the amplitude, phase or polarization of a spectral component of an input optical spectrum.

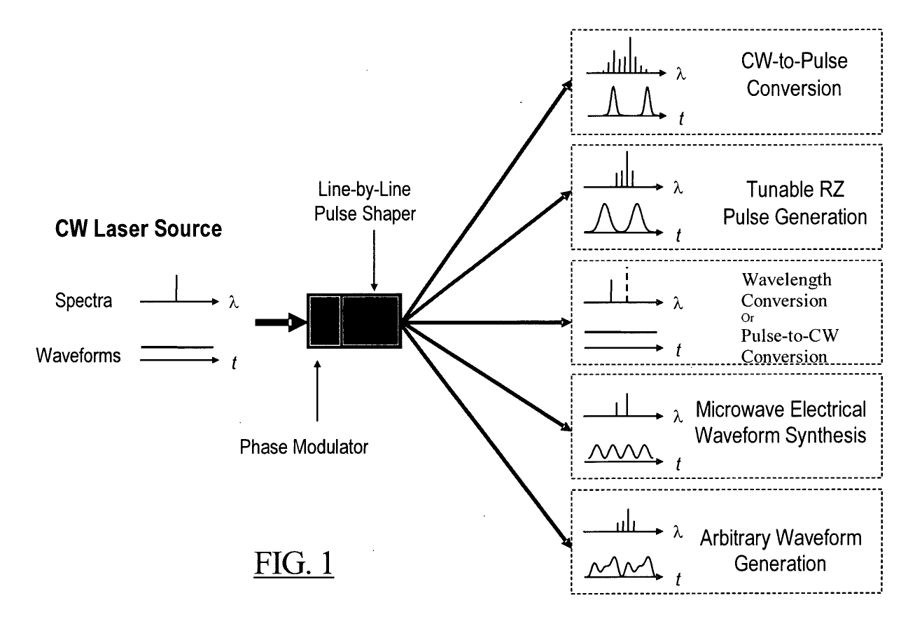

FIG. 1 schematically illustrates examples of waveforms which may be generated or processed, such as by filtering, using the apparatus and method described herein. Various applications include CW-to-pulse conversion, width and wavelength tunable return-to-zero pulse generation, pulse-to-CW conversion, wavelength conversion, microwave electrical waveform synthesis, optical or electrical arbitrary waveform generation, and the like. From the pulse shaping perspective, essentially full-pulse-shape control may be achieved when the individual spectral lines are independently manipulated. Specifically, the wavelength of the pulses can be tuned within the envelope of the input spectrum, and the width of the pulses can be tuned down to a duration limited by the inverse of the input spectrum bandwidth. The optical signals may be converted to electrical signals in a electro-optical detector, such as a photodiode, or the like.

O-AWG can be used to produce, for example, return-to-zero (RZ) pulses with tailored pulse width and chirp, which may be useful for RZ-format data transmission, soliton systems, optical time division multiplexing and optical packet generation. In many optical code division multiple access (O-CDMA) systems, ultra-short input pulses are time-spread during the encoding process into lower intensity noise-like signals. O-AWG can be used to produce such encoded signals with desired properties, such as longer code lengths and, in some cases, reduced fluctuations. O-AWG and line-by-line pulse shaping may also be used for spectral line stabilization and optical frequency metrology, since the pulse characteristics are sensitive to the spectral line positions.

The optical spectral lines (optical frequency comb) can be expressed as:
fₙ=nfᵣₑₚ+ε
where n is a large integer, fᵣₑₚ is the optical frequency interval between two spectral lines (also the temporal repetition rate of a mode-locked laser), and ε is the comb-offset frequency. The offset frequency ε is related to the evolution of the carrier-envelope phase, which may occur as the result of a mismatch in the group and phase velocities inside the laser cavity.

A variety of optical sources may used, including a mode locked laser, a continuous wave (CW) laser followed by periodically driven phase or amplitude modulators, or a optical cavity having an optical modulator such that the cavity mode spacing is equal to a modulation frequency or sub- harmonic frequency. Generally these may be considered as optical frequency comb generators.

A modulated CW laser may have lower complexity, simple tuning of the comb offset frequency, continuous tunability of the spectral line separation (the repetition rate), and reasonably stable operation without active control. The modulated cavity generator may have higher stability combined with a broad optical bandwidth (that is, a large number of comb lines). The output of the modulated cavity generator is a periodic train of optical pulses where the repetition frequency determines the separation in the optical domain between adjacent pulses. The duration of each pulse determines the overall optical bandwidth, and thus the shorter the pulse duration, the broader the bandwidth, and the larger the number of spectral lines. The pulse output duration of the optical pulse generator may be further decreased by passing the signal through a dispersion-decreasing-fiber soliton compressor, such as the PriTel FP-400, available from PriTel, Inc (Naperville, Ill.). Such a pulse processing has been used to decrease a pulse from a duration of 2.76 ps to about 324 fs.

Optical sources are continually being developed and improved, and nothing in the examples herein is intended to suggest that a particular type of signal source is required.

Using line-by-line processing the characteristics of individual spectral lines may be independently and programmatically controlled. Characteristics may include intensity, phase or polarization, and these characteristics may be time varying.

The input optical beam may have a known polarization state (usually linear polarization), and the output optical beam may also have a linear polarization (usually by a polarizer that converts a polarization transformation caused by the spatial optical modulator into an amplitude change). This transformation may be called scalar pulse shaping, as polarization state of the output (or input) beam does not change in a frequency or time-dependent manner.

However, pulse shapers may be configured and operated such that the output signal has a polarization that varies with respect to the input signal with at least one of frequency or time. This may be termed vector pulse shaping, as the vector direction of the output electrical field varies in at least one of frequency or time. At least one of the amplitude or phase may also be controlled so as to vary in at least one of frequency or time. Vector pulse shaped fields may be used for control of high harmonic generation for attosecond pulse generation schemes, for the emulation and mitigation of pulse distortion due to polarization mode dispersion (PMD) in fiber systems, and the like.

Vector pulse shaping can also be used in the processing of signals where the input field has a polarization that varies in at least one of frequency or time. In an example, signals distorted by polarization mode distortion (PMD) in transmission on a fiber optic communications system, tend to have an optical frequency variation in polarization state. A vector pulse shaper may be used, for example, to substantially align the frequency dependent polarizations, such that an output signal has a polarization state that is substantially independent of frequency and time.

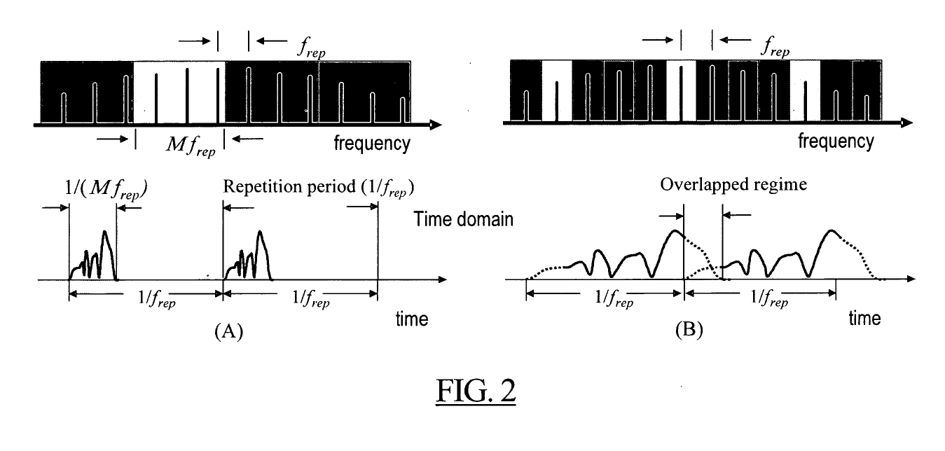

Group-of-lines pulse shaping, which is known, is illustrated in FIG. 2a. In this technique, individual adjacent spectral lines are not resolved sufficiently for that the characteristics of adjacent lines to be independently modulated. When the processing occurs M lines at a time, the resulting shaped pulses have maximum duration ˜1/(Mfrep) and repeat with period T=1/frep. Such pulses are thus isolated from one another in time as the duration of each pulse is less than the repetition period. However, using line-by-line pulse shaping (M=1) as shown in FIG. 2(b), the shaped pulses may overlap each other, leading to interference between different input pulses in the overlapped region. Waveforms with unity duty cycle, spanning the full time aperture corresponding to the modulation period of the input comb source, can be generated. Whereas, in group-of-lines shaping in which adjacent lines cannot be filtered substantially independently, the generated waveforms have duty cycle of less than unity. By independently manipulating the characteristics of individual spectral lines (line-by-line pulse shaping), essentially arbitrary optical waveform generation and related optical processing may be performed.

The line-by-line pulse shaping apparatus and method can also be used with broadened spectral lines caused by data-modulated waveforms. In an example, line-by-line filtering can be applied to perform a variety of useful processing operations on temporally modulated optical data. In addition to format conversion such as RZ-to-NRZ, another example is an optical differential phase shift keying (DPSK) receiver.

A DPSK receiver may detect binary phase-shift-keying data by coherently adding the received signal to a replica of the received signal which has been delayed by one bit period. The interferometric addition of the signal and a delayed replica thereof yields a high (low) output when the phase of the adjacent bits are the same (different by π). The delay-by-one-bit-and-add operation is equivalent to cosine-shaped frequency filter, which may be realized by a line-by-line pulse shaper.

The above non-exhaustive class of examples illustrates some of the applications of line-by-line optical spectral manipulation, and other such applications will be easily appreciated by a person of skill in the art.

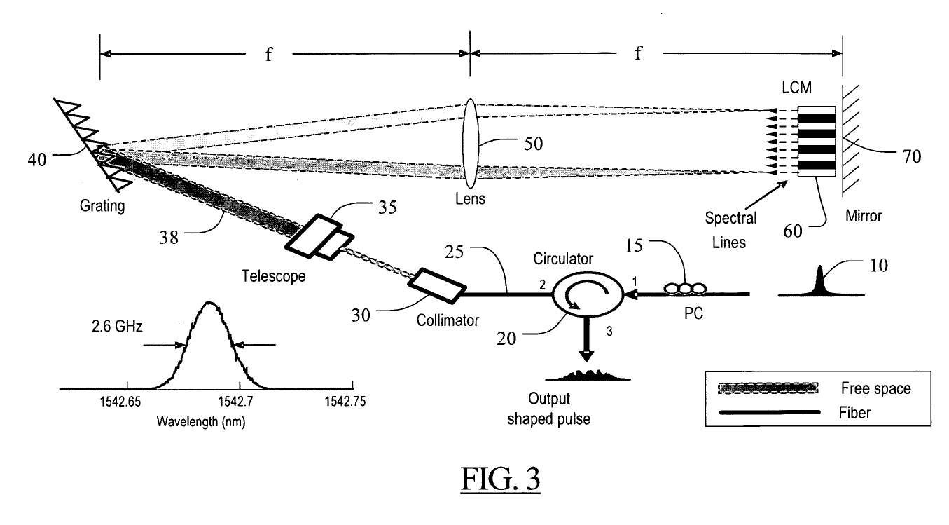

In another aspect, spectral line-by-line processing for optical arbitrary waveform generation (O-AWG) can be performed by, for example, a high-resolution fiber-coupled Fourier-Transform (FT) pulse shaper, in reflection or in a transmission geometry. FIG. 3 shows an experimental apparatus for a reflective geometry line-by-line FT processor. A similar FT pulse shaper was disclosed in U.S. patent application Ser. No.: 11/418,585 (2007-0019282A1) filed on May 4, 2006, which is commonly assigned, and which is incorporated herein by reference.

In this example, an optical signal 10 may be input to the apparatus from a mode-locked laser having a pulse repetition rate of 10 GHz. A polarization controller 15 is manipulated so as to produce an optical signal with a linear polarization matched to the characteristics of the diffraction grating 40 so as to increase the efficiency of light transmission. The optical signal passes through a circulator 20 and is coupled by a optical fiber 25 to a collimator 30 disposed to project the light through a telescope 35 on to the diffraction grating 40. In this example, the collimator magnifies the beam size (˜18 mm diameter) and projects the light through the telescope onto a diffraction grating (1200 groove/mm). The optical path in free space is shown as a shaded area and the optical path in a fiber medium is shown as a heavy line.

Discrete optical spectral lines arising from the periodic short input pulses are diffracted by the grating 40 and directed by a lens 50 (1000 mm focal length) onto the spatial modulator 60. A 2×128 pixel liquid crystal modulator (LCM) array 60 with a polarizer (not shown) on the input face thereof is placed just before the mirror 70 to modify at least one of the amplitude or phase of individual spectral lines. Any other amplitude and/or phase modulator device could be employed with similar results. A mirror 70 at the lens focal plane produces a reflective geometry and redirects the spectral lines from the pixels of the LCM onto the grating 40. The processed spectral lines of the reflected energy are recombined into the fiber 25 and may be output through the optical circulator 20. For clarity, only the upper and the lower optical frequency paths that are processed by the LCM 60 are shown in the region between the grating 40 and the mirror 70. Transmission mode geometries may also be used and have separate input and output sections.

In apparatus of this example, the measured 3 dB passband width of the line-by-line pulse shaper is 2.6 GHz, as was shown in the inset in FIG. 3. Such spatial optical resolution permits substantially independent line-by-line control of the characteristics of individual spectral lines, separated by the ˜10 GHz laser repetition rate, which may appropriate for, for example, applications in optical communications and RF photonics. The characteristics of each spectral line that may be controlled may include the amplitude, phase and polarization, and this control may also have temporal aspects for each spectral line.

The component parameters in the apparatus are selected or adjusted such that each of the spectral lines of the comb may be dispersed by the grating so that the spatial separation of the individual spectral lines projected onto the surface of the LCM is such that an individual spectral line may be associated with a pixel. This situation can be realized, for example, by tuning the frequency of modulation of the laser, the repetition rate of the laser, or orienting the angle of the diffraction grating with respect to the remainder of the apparatus.

For accurate line-by-line control, the spectral line spacing of the source (the repetition rate) may be adjusted so as to match the spatial spacing of the pixels (or integer multiple of the pixel spacing) of the LCM.

In an example, a periodically modulated continuous-wave (CW) laser may be used to generate spectral lines which may be used to show various optical signal processing methods including CW-to-pulse conversion, width and wavelength tunable return-to-zero (RZ) pulse generation, pulse-to-CW conversion, wavelength conversion, and microwave electrical waveform synthesis.

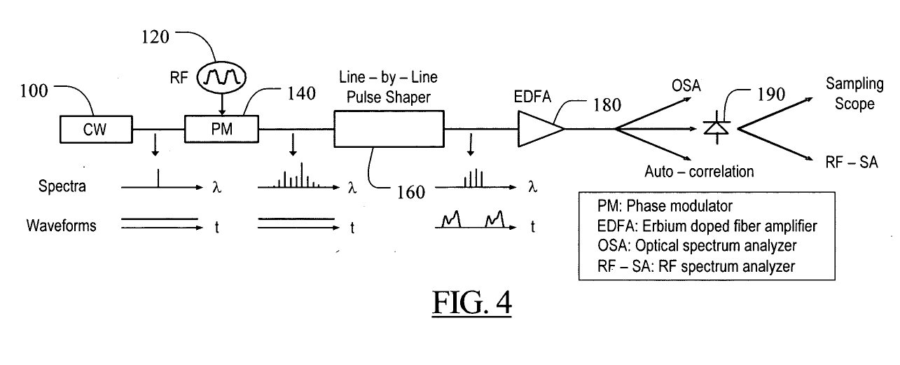

An apparatus suitable for this purpose is shown at the top of FIG. 4. Underneath each stage of the apparatus, the optical spectrum and the associated temporal waveform is shown schematically. A tunable CW laser 100 is modulated by a phase modulator 140 driven by a high-frequency source 120, such as a clock signal from a bit-error-rate test set. The generated spectral lines are then manipulated by the spectral line-by-line pulse shaper 160. The resulting optical signal was measured by an optical spectrum analyzer (OSA) and an intensity auto-correlation measurement apparatus. The output signal was also detected by a 50 GHz bandwidth photo-diode 190 and measured by a RF spectrum analyzer (RF-SA) and a sampling oscilloscope. The optical phase modulator used had a V_{π} of 5 V, and the driving peak-to-peak voltage of the clock signal was approximately 9.5 V. In an alternative, for example, an optical intensity modulator may be used in place of the phase modulator for the purpose of spectral comb generation. The transmission loss in the system was compensated by an Erbium-doped fiber amplifier (EDFA) 180.

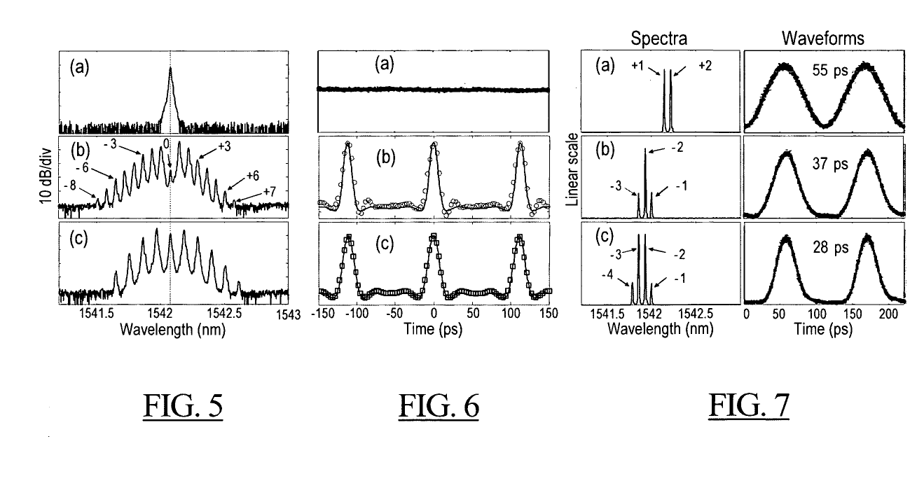

FIG. 5(a) shows the optical spectrum of a CW laser, characterized as a single spectral line. FIG. 5(b) shows the generated optical spectral lines when the phase modulator is driven by a 9.0 GHz clock signal. At least 16 spectral lines have been generated, covering a bandwidth of about 135 GHz. Such a bandwidth may be useful for optical fiber communications and microwave electrical waveform synthesis applications. FIG. 5(c) shows spectral lines associated with a 13.5 GHz driving signal (with similar overall bandwidth), demonstrating controllability of the spectral line separations. Hereinafter, spectral lines with 9.0 GHz separation as shown in FIG. 5(b) are used in the examples, unless otherwise specified. It will be understood that the specific repetition rates, spectral line widths and other characteristics are representative of the equipment used to demonstrate the technique in this example and are not to be considered as suggesting a limitation on the parameters which may be used or the type of optical sources, modulators or other components which may exist or may be developed.

FIG. 6(a) shows the optical time-domain waveform corresponding to FIG. 6(b), as measured by a sampling oscilloscope. The phase-modulated optical waveform amplitude remains at essentially a constant intensity since only the temporal phase is modulated. The line-by-line pulse shaper 160 is used to manipulate the spectral lines of the modulated CW laser so as to demonstrate optical processing capabilities. The LCM pixel spacing is matched to the 9.0 GHz spectral line spacing by setting an appropriate grating diffraction angle. By correcting the spectral phase of the individual optical spectral lines using the line- by-line pulse shaper while maintaining the spectral line intensity, the modulated CW signal is converted to an almost transform-limited pulse train, as shown in FIG. 6(b). The measured sampling scope traces (circles) have a full width at half maximum (FWHM) of 15 ps while the calculated transform-limited pulses (solid line) have a FWHM of 12 ps, based on the spectrum shown in FIG. 5(b). The slight deviation between the experiment and the calculation may be due to the limited electrical bandwidth of the 50 GHz photo-diode. The measured optical intensity auto-correlation function of the generated pulses (17 ps, squares) and the calculated transform-limited pulse intensity auto-correlation function (16.5 ps, solid line) are shown in FIG. 6(c). The agreement between the two measurement techniques shows that the CW signal is converted to almost transform-limited pulses, as short as 12 ps, in this example.

The +1, +3, +5, +6, −6, and −7 order optical spectral lines in FIG. 5(b) are controlled to have a π phase shift while the other optical spectral lines have 0 phase shift. The spectral phase of the modulated CW laser was first estimated by calculation, and then a conjugate spectral phase was applied and adjusted by the pulse shaper until the shortest pulses were obtained. All of the spectral lines of the phase modulated CW laser have 0 or π phase shift with respect to the adjusted spectral phase.

FIG. 7 shows an example of width and wavelength tunable return-to-zero (RZ) pulse generation. The pulse width is proportional to the inverse of the spectral bandwidth (after phase correction), or proportional to the number of the spectral lines used for a fixed modulation frequency. The spectra are processed by the pulse shaper to have (a) two lines, (b) three lines and (c) four lines (linear scale spectra are shown to compare the relative intensities of spectral lines). That is, the processing suppressed the other spectral lines by setting their amplitude to zero. The corresponding pulse full-width-at-half-maxima (FWHM) are 55 ps, 37 ps and 28 ps, respectively, agreeing satisfactorily with the calculated waveforms.

For two spectral lines, the ideal waveform intensity profile in the time domain corresponds to a squared cosine function. The waveform in FIG. 7(a) demonstrates a 9.0 GHz cosine function. Together with the 12 ps pulses demonstrated in FIG. 6, a pulse width tuning range of 12 ps to 55 ps at 9.0 GHz repetition rate has thus been demonstrated. The pulses in FIG. 7 have different but adjustable center wavelengths, associated with the selection of the specific spectral lines, demonstrating a wavelength tunability function. A larger wavelength tuning range can be achieved by tuning the CW laser center wavelength. Width and wavelength tunable pulses may be used in optical fiber communication systems and optical networks, including return-to-zero (RZ) format transmission, soliton systems, optical time-division-multiplexing, optical code-division-multiple-access, and optical packet generation, and the like.

FIG. 8(a) shows a single spectral line which has been selected from a comb of spectral lines by the line-by-line processor, and which is at a different optical wavelength from the input CW optical wavelength. The other optical spectrum lines in the comb of spectral lines are almost completely suppressed (more than about 39 dB) and are obscured in the noise background. FIGS. 8(b) and (c) show the corresponding electrical waveform detected by a photo-diode and the corresponding RF spectrum, respectively. The single large spectral line produces a DC signal (FIG. 8(b)) and the beating between the single large spectral line and the residual optical signal comb produces the CW electrical signal at the modulation frequency. The 45 dB contrast ratio between DC (FIG. 8(b)) and the first harmonic (FIG. 8(c)) suggests as much as 54 dB suppression ratio in the optical spectrum modulation assuming there are two equal un-suppressed lines around the single desired line.

Together with the pulse generation method demonstrated in FIGS. 6 and 7, the combination demonstrates pulse-to-CW conversion function. If data is modulated onto the pulses, this conversion essentially accomplishes RZ-to-NRZ format conversion. Further, the input CW optical signal and filtered output CW optical signal, demonstrates CW-to-CW optical wavelength conversion. The almost pure CW optical wavelength conversion demonstrated here may be used, for example, to reduce crosstalk in wavelength conversion for dense wavelength-division-multiplexing (WDM) systems. Optical wavelength conversion based on this technique is also possible when data is modulated on the CW optical signal. In such cases spectral lines are broadened by the random data modulation.

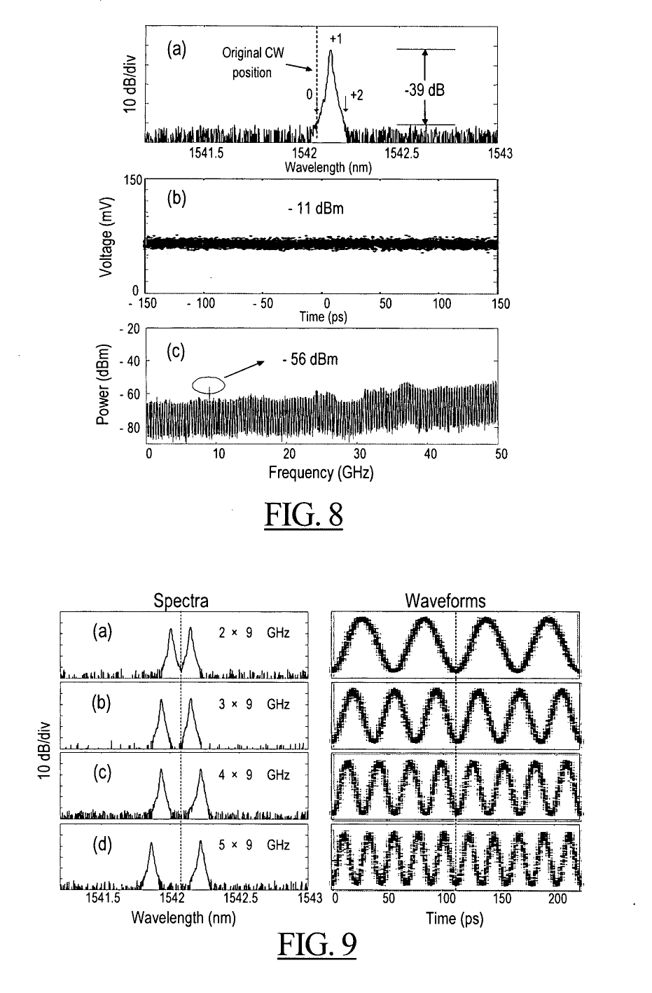

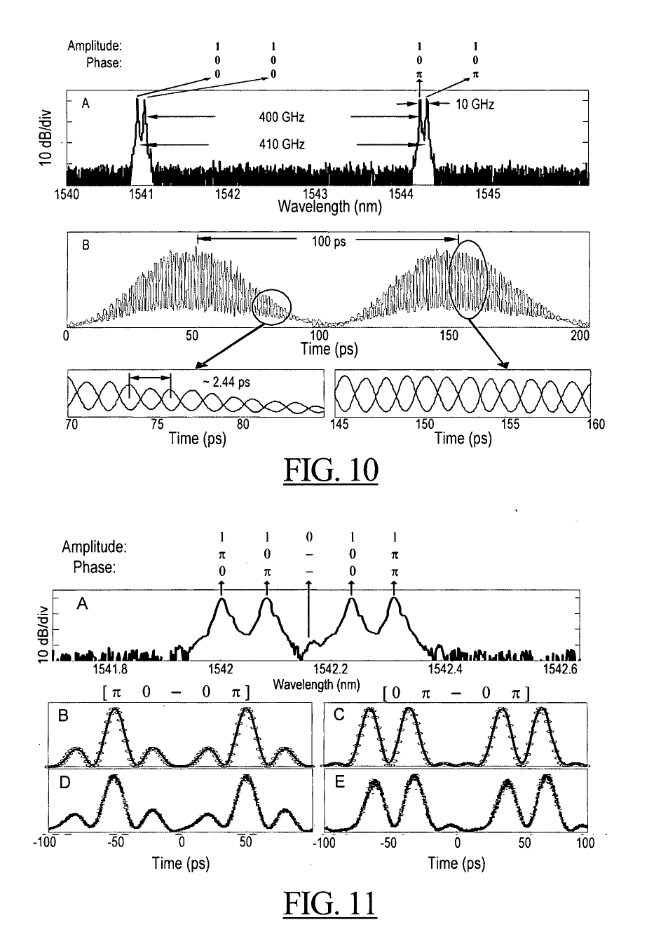

FIG. 9 shows microwave electrical waveform generation by selecting two optical spectral lines with different optical frequency separations. The electrical waveforms are obtained by opto-electric (O/E) conversion of the incident optical signal using a 50 GHz photo-diode: 18 GHz, 27 GHz, 36 GHz and 45 GHz waveforms are shown. Other microwave frequencies and their harmonics can be generated by tuning the driving frequency (for example, 13.5 GHz and harmonics thereof may be generated using the spectra shown in FIG. 5(c)). Optically produced microwave signals may be used for any purpose where a microwave signal waveform is desired, including ultra-wideband (UWB) wireless communications, impulsive radar, radio-over-fiber, and the like.

In a further example, a mode-locked laser is used to generate optical spectral lines and illustrates optical arbitrary waveform generation (O-AWG). The apparatus is similar to FIG. 4; however, the CW laser and phase modulator are replaced by a harmonically mode-locked fiber laser (not shown) producing ˜400 fs duration full-width-at-half-maximum pulses at a 10 GHz repetition rate, with an optical central wavelength of 1542.5 nm. The mode-locked laser creates a large number of optical spectral lines, resulting in a large bandwidth.

Arbitrary waveforms may be produced or an input optical signal filtered, since the characteristics of each of the plurality of spectral lines may be independently manipulated. FIG. 10 shows an example of O-AWG obtained by manipulating multiple spectral lines over a broad optical band. Two pairs of spectral lines are selected from the plurality of equally spaced spectral lines intensity modulated to yield a pair of spectral lines with a 10 GHz frequency separation therebetween, and a 410 GHz center-to-center frequency separation between pairs of spectral lines (FIG. 10(a)). In the time domain representation shown in FIG. 10(b), the 100 ps period of the waveform envelope is determined by the 10 GHz spacing between lines within a single pair of spectral lines, while the ˜2.44 ps period of waveform oscillation is determined by the average 410 GHz spacing between the spectral line pairs). Fine-scale waveform control may, for example, use a π phase shift applied to one pair of spectral lines while keeping the spectral amplitude essentially unchanged. Two examples are shown, where the phases of the pairs of lines have the same phase shift, and where the second pair of lines are shifted by π with respect to a first pair of lines. The resulting time- domain waveform will be out of phase with the waveform without the phase shift, as seen in the zoomed traces of FIG. 10(c). The finite contrast of the waveform oscillation minimum points, which should, in theory, be zero intensity, may be due to the finite duration of the 400 fs reference pulses used for the measurement. Thus, waveform manipulation at both macro and micro scale is possible simultaneously.

FIG. 11 shows another example of O-AWG. Four spectral lines (five consecutive lines with the center line blocked, as shown in FIG. 11(a) are selected within a relatively narrow optical bandwidth. By applying the same amplitude modulation ([1, 1, 0, 1, 1]) but different phase modulation ([π, 0−0, π] or [0, π−0, π]), two distinct waveforms are generated. The intensity cross-correlation measurements shown in FIGS. 11b-c are in agreement with the calculations based on the Fourier transform of the nominal amplitude and phase patterns imparted onto the spectral lines. This demonstrates that arbitrary optical waveforms with desired amplitude and phase characteristics may be synthesized by manipulating the individual spectral lines from an optical frequency comb. It should also be noted, that to clearly illustrate the relationship between the time and frequency domains in this and preceding examples, intensity and phase control are controlled in a binary fashion (e.g. 0,1; 0 π); grey levels, that is, intermediate values of intensity and phase, are equally possible.

In another aspect, O-AWG may be used for the generation of radio-frequency electrical waveforms (RF-AWG). FIGS. 11(d-e) show sampling oscilloscope measurements of the electrical output generated when the optical waveforms of FIGS. 11(b-c) are opto-electrically converted by a photodiode having a 50 GHz bandwidth. The slight distortions of the RF waveforms compared with the driving optical signals are believed to be caused by the limited bandwidth of the photodiode and sampling scope, which could be pre-compensated (for example, to achieve two equal main peaks in FIG. 11(e) by appropriately modifying the modulating signals supplied to the O-AWG apparatus.

In the previous examples, the optical spectral lines are typically narrow spectral lines arising from periodic waveforms. The line-by-line processing technique may also be used with broadened spectral lines which may arise, for example, from optical data representing temporally modulated waveforms.

In another example, the line-by-line pulse shaping technique is used to perform all-optical return-to-zero to non-return-to-zero (RZ-to-NRZ) modulation format conversion. The RZ modulation format has been employed in long-haul fiber transmission systems, as it may have a higher tolerance to impairments caused by fiber transmission effects; however, the NRZ format is more spectrally efficient and may be used, for example, in local and metro access networks. All-optical conversion from RZ-to-NRZ format may be useful at the interface between backbone and access networks.

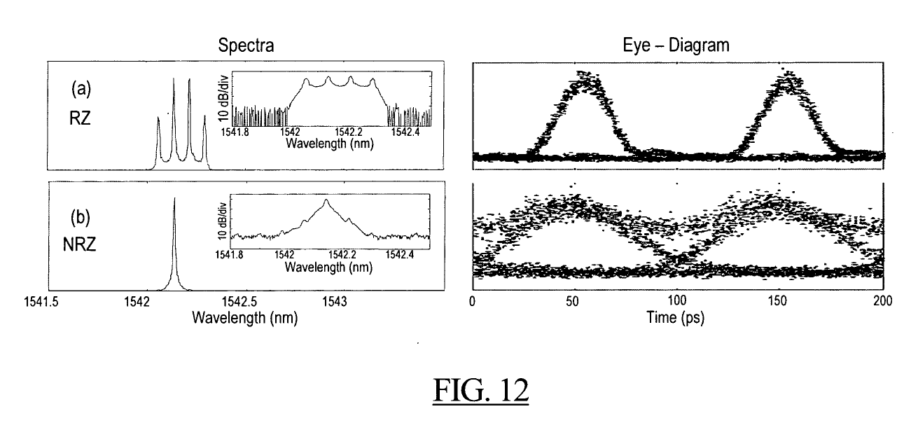

The RZ pulses are temporally modulated and become an RZ-format data stream. FIG. 12(a) shows RZ format optical pulses temporally modulated by a 10 Gb/s pseudo-random bit stream (PRBS) having a maximal length sequence of 2²³-1. The data stream of 4 spectral lines (25 ps pulses) is transmitted by a line-by-line pulse shaper. Compared with the un-modulated spectra shown previously, each spectral line of the modulated spectra is broadened by the data modulation. The modulated waveforms are detected by a 50 GHz bandwidth photo-diode in which the RZ format is evident. In FIG. 12(b) only one spectral line is permitted to pass through the line-by-line pulse shaper. As a result, the RZ format is converted to NRZ format, as shown by the eye-diagram, which is also detected by the 50 GHz bandwidth photo-diode.

The non-ideal properties of the converted NRZ format (uneven “1” level) may be caused by imperfect suppression of adjacent spectral lines (˜20 dB suppression ratio) as shown by the log-scale optical power spectra in the figure insets. The “1” level can be made flatter by narrowing the pulse shaper filter bandwidth to further suppress undesired lines, but the eye-diagram may become noisy and performance may degrade. The increased noise may be caused by optical frequency fluctuations in the mode-locked laser comb of this experimental apparatus. Filtering the spectrum to one single line (NRZ format) may result in a higher sensitivity to such fluctuation than filtering to produce multiple spectral lines (RZ format), as evidenced by different noise levels in the eye-diagrams. This limitation may be overcome, for example, by using a source with better optical frequency stability.

The performance of the generated 25 ps RZ signal format and converted NRZ signal format has been confirmed by bit error rate measurement. For both data formats, less than a 10⁻¹⁰ bit error rate can be achieved using a standard 10 Gb/s receiver for both back-to-back testing and after 25 km single-mode fiber transmission, without dispersion compensation. The line-by-line pulse processing performance may be improved with an optical-frequency-stabilized mode-locked laser. In the present example, only a single line-by-line pulse shaper was used to perform the RZ-to-NRZ format conversion. Alternatively, a first line-by-line pulse shaper can be used to generate the RZ format with desired wavelength and width, while a second line-by-line pulse shaper can be used to implement RZ-to-NRZ format conversion.

The time duration of the RZ pulses may be discretely tuned by changing the number of spectral lines used. The pulse width may be continuously varied by controlling not only the number of lines but also the relative amplitudes of the selected lines using a programmable amplitude line-by-line processor.

The update speed of LCM used in the apparatus used in these examples is on the order of about tens of ms to about 100 ms, limited by the liquid crystal relaxation time. The pulse shaping examples disclosed herein generated waveforms periodic at the repetition rate of the mode-locked laser source. To generate waveforms with a different period, the repetition rate of the laser may be changed. Accordingly, the pulse shaper design or operation would be modified to match the spectral line separation (the repetition rate of the laser). Alternatively, if a faster spatial light modulator technology capable of update at substantially the laser repetition rate were available, then aperiodic waveforms or waveforms with periodicities different than that of the input laser could be generated via appropriate reprogramming of the spatial light modulator on a pulse by pulse basis. Intermediate modulator temporal response characteristics are equally possible.

In another aspect, the apparatus is a pulse shaper adapted to accept an optical signal and a modulating signal, and including means for spatially dispersing the optical spectrum of the optical signal, and means for modulating at least one characteristic of the spatially dispersed optical signal. The means for modulating substantially independently modulates each of a pair of adjacent optical spectral elements of a comb-like optical spectrum.

The means for spatially dispersing the optical signal may be a diffraction grating as in the examples described; other dispersers, having higher spatial dispersion and/or integrated devices, can also be used for such purposes. For example, virtually-imaged phased-arrays (VIPA) and array waveguide gratings (AWG) may be used as dispersers in the place of the diffraction grating.

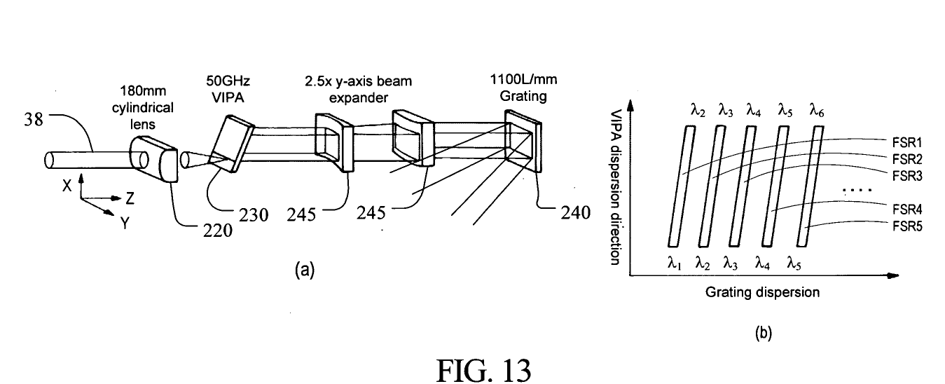

In yet another aspect, two dispersive devices may be operated in cascade in order to increase the spectral resolution. That is, if a single dispersion device may be termed one-dimensional (1-D) spectral dispersion, the use of two dispersion devices may be termed two-dimensional (2-D) spectral dispersion. FIG. 13(a) illustrates a 2-D device comprised of a VIPA and a diffraction grating. This VIPA of this apparatus may be inserted between the telescope 35 and the grating 40, shown in FIG. 3 to result in a 2-D spectral dispersion. The LCM modulator would also be a 2-D device. A ˜2 mm beam 38 may be focused into a VIPA 230 (such as is available from Avanex, Freemont, Calif.) by a cylindrical lens 220. The VIPA may have a free spectral range (FSR) of 50 GHz (0.4 nm) and periodically disperses segments of 50 GHz of optical bandwidth in the x-coordinate direction. The VIPA may tilted slightly (about 3°) in the z-coordinate direction, resulting in about 2.15°/nm of angular dispersion. A grating 240 having 1100 lines/mm was disposed after the VIPA so as to spatially separate each of the FSRs of the VIPA in the y-coordinate direction. The grating 240 was disposed such that the incident light beam made an angle of about 71° with respect to a normal to the grating surface. This yields an angular dispersion of 0.097°/nm.

FIG. 13(b) conceptually shows that the VIPA disperses the input signal in a first coordinate direction, and the optical grating disperses the signal of each FSR of the VIPA in a second substantially orthogonal coordinate direction.

In order to increase the FSR spatial resolution, and thus have more physical separation of the optical wavelengths, a 2.5 times y-axis beam expander 245 was placed between the VIPA and the grating, resulting in a beam width at the grating of about 5 mm. The remainder of the pulse shaper is the same or similar to that of FIG. 3, where the mirror is again disposed in the focal plane of the imaging lens. In this manner, the spectrum is spread in two dimensions. This results in increased optical spectral resolution for a modulating device having a fixed pixel size. Typical LCM devices are usually fabricated as a matrix of N×M pixels such as would be used in an image display. Yet, in a one dimensional device, only N or M pixels may be used to perform the modulation function. When the 2-D optical dispersion configuration is used a total of N×M individual spectral resolution elements may be created. This may substantially increase the bandwidth or the number of degrees of freedom available for producing a optical or electrical signal having arbitrary characteristics.

The means for modulating may include liquid-crystal-display-like structures, amplitude modulators, phase modulators and the like. Fixed characteristic masks may be used in place of the variable modulation means when the characteristics of the resultant signal may not be expected to be changed frequently.

Substantially independently modulating adjacent optical spectral elements of a comb-spectrum is intended to be interpreted in the context of a particular application, where the desired characteristics of the output signal may be related to the relative independence of the changes to the characteristics of the adjacent spectral lines. This may relate to the maximum attenuation of each element of the spatial modulator and other practical considerations. Such considerations were discussed, for example, with respect to the RZ-NRZ conversion example of FIG. 12 or the generation of a CW signal as in the example of FIG. 8.

Many of the examples presented herein use bulk optics and free-space propagation for the optical paths. Such arrangements are convenient for experimentation and some uses, however a person of skill in the art will appreciate that many of the optical paths may be realized in optical fibers or other integrated optics devices, or functions may be performed in optical waveguides, such as fibers, and by electro-optic materials such as LiNbO3, and the like, which now exist or may subsequently be developed. Nothing herein should be interpreted to require the use of a specific optical component for a particular function. Further, the grouping of optical components into functional units for descriptive purposes is not meant to require such groupings for other embodiments.

It is therefore intended that the foregoing detailed description be regarded as illustrative rather than limiting, and that it be understood that it is the following claims, including all equivalents, that are intended to define the spirit and scope of this invention.

What is claimed is:

1. An apparatus for processing an optical signal, comprising:
a wavelength-dependent optical modulator;
an input section adapted to couple an optical signal from a source to the wavelength-dependent optical modulator; and
an output section adapted to couple an output of the wavelength dependent optical modulator to an output port,
wherein the wavelength-dependent optical modulator has an optical frequency resolution such that adjacent spectral lines of an optical frequency comb are substantially independently modulated.

2. The apparatus of claim 1, wherein the input section and the output section are the same device.

3. The apparatus of claim 2, wherein the device is an optical circulator.

4. The apparatus of claim I, wherein a portion of the input section accepts light from the optical source and disperses the light, and the dispersion is a function of optical wavelength.

5. The apparatus of claim 4, wherein the portion of the input section includes an arrayed wavelength grating (AWG).

6. The apparatus of claim 4, where the portion of the input section includes a diffraction grating.

7. The apparatus of claim 4, wherein the portion of the input section is a virtually imaged phased array (VIPA).

8. The apparatus of claim 4, wherein the dispersed light is imaged onto a reflecting portion disposed at a focal length of an optical apparatus.

9. The apparatus of claim 8, where the reflecting portion is a mirror.

10. The apparatus of claim 9, wherein a modulating portion is disposed between the diffracting portion of the input section and the mirror and the modulating portion is placed in close proximity to the mirror.

11. The apparatus of claim 10, wherein the modulating portion is a liquid crystal modulator.

12. The apparatus of claim 10, wherein the modulating portion is a mask.

13. The apparatus of claim 1, wherein the spectral line is modulated by changing at least one of the amplitude, or the phase, or the polarization of the spectral line.

14. The apparatus of claim 1, wherein the output section is adapted to couple a free space wave to an optical fiber.

15. The apparatus of claim 4, wherein the dispersion is performed sequentially in substantially two orthogonal axes.

16. The apparatus of claim 15, wherein a virtual-imaged phased array (VIPA) having a free spectral range (FSR) is disposed to disperse an optical signal in a first coordinate direction, and an optical grating is disposed to disperse the optical signal output from the VIPA in a second coordinate direction.

17. The apparatus of claim 1, further comprising a modulating portion disposed at a Fourier image plane, and the modulating portion configured so as to modulate signals spatially dispersed along two axes of the image plane.

18. The apparatus of claim 17, wherein the modulating portion is a liquid crystal module (LCM) having independently controllable pixels.

19. The apparatus of claim 1, wherein the output port is coupled to a photodiode.

20. The apparatus of claim 1, wherein the output port is coupled to a photodiode by a circulator.

21. An apparatus for producing electrical or optical waveforms, comprising:
a pulse shaper adapted to accept an optical signal and a modulating signal, the pulse shaper further comprising:
a spatial optical modulator, wherein the optical signal has comb-like spectral elements and the spatial optical modulator is adapted to substantially independently control at least one characteristic of at least a pair of adjacent spectral elements in response to the modulating signal.

22. The apparatus of claim 21, wherein the characteristic of a pair of optical spectral elements is one of amplitude, phase or polarization.

23. The apparatus of claim 21, further comprising an optical to electronic converter.

24. The apparatus of claim 21, wherein the pulse shaper is an integrated optics device.

25. The apparatus of claim 24, wherein the integrated optics device includes an arrayed wavelength grating (AWG).

26. A method of producing a waveform, the method comprising:
providing an optical disperser capable of dispersing an optical signal in a coordinate axis;
providing spatial modulator; and
modifying at least one characteristic of the dispersed optical signal,
wherein the optical signal is comprised of discrete spectral lines dispersed such that the modifying the characteristic may be performed substantially independently on adjacent spectral lines.

27. The method of claim 26, further comprising providing a mirror disposed immediately behind the spatial modulator and disposed so as to reflect the optical signal back along a reciprocal path.

28. The method of claim 26, wherein the optical signal is dispersed in an integrated optics device.

29. The method of claim 28, wherein the integrated optics device includes an arrayed wavelength grating (AWG).

30. The method of claim 28, wherein the integrated optics device includes a ring resonator array.

31. The method of claim 26, wherein the optical signal is dispersed in two coordinate axes.

32. The method of claim 26, wherein an optical source with a comb spectrum is coupled to the optical disperser.

33. The method of claim 32, wherein the coupling of the optical source is by an optical circulator.

34. A method of producing a waveform with arbitrary characteristics, the method comprising:
providing a modulator adapted to accept an optical signal having substantially comb-like optical spectrum elements;
spatially dispersing the optical signal;
substantially independently modulating at least one characteristic of at least two of the comb-like optical spectral elements in response to an input modulating signal; and
recombining the modulated optical signal and outputting the modulated optical signal.

35. The method of claim 34, wherein the comb-like spectrum is modulated so as to produce a continuous wave optical signal.

36. The method of claim 34, wherein the comb-like spectrum is modulated so as to produce a pulsed optical signal.

37. The method of claim 34, wherein the comb-like spectrum is modulated so as to produce an optical signal, wherein at least one of the intensity, phase, or polarization of the optical signal have a controlled time variation.

38. The method of claim 34, wherein an RZ data signal is converted to a NRZ signal by modulating the spectral lines.

39. The method of claim 34, wherein a phase coded data signal having a substantially comb-like optical spectrum is processed for a differential phase shift receiver by modulating spectral lines thereof.

40. The method of claim 34, further comprising detecting the output modulated signal in an opto-electric converter.

41. The method of claim 34, wherein the opto-electric converter is a photo-diode.

42. An apparatus for producing a signal, comprising:
means for coupling an input optical signal;
means for spatially dispersing the input optical signal;
means for modulating the spatially dispersed input optical signal;
means for outputting the modulated signal,
wherein the input signal is an optical signal having at least two spectral lines, and the modulator acts on each of the spectral lines substantially independently.

43. The apparatus of claim 42, further comprising:
means for converting the output optical signal to an electrical signal.
